(19) United States
(12) Patent Application Publication
(10) Pub. No.: US 2015/0192997 A1
(43) Pub. Date: Jul. 9, 2015

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: Koichi Nakagawa, Kawasaki-shi (JP)

(21) Appl. No.: 14/588,182

(22) Filed: Dec. 31, 2014

(30) Foreign Application Priority Data
Jan. 6, 2014 (JP) 2014-000445

(51) Int. Cl. G06F 3/01; G06T 11/00; G06F 3/041

(52) U.S. Cl. CPC G06F 3/016; G06F 3/041; G06T 11/001

(57) ABSTRACT

To provide a mechanism for easily setting a tactile sensation to be given to a user when the user touches an image, an information processing apparatus includes a display that displays an image and includes an input plane for performing a touch operation, a detection unit that detects a touch operation on the input plane, a setting unit that sets the area of an image corresponding to a touch position of the touch operation on the input plane as a tactile area for giving a tactile sensation, and a drawing control unit that applies a color over the displayed image by using a different color according to a tactile sensation type to enable recognizing the tactile area set by the setting unit.

### BACKGROUND

1. Field

Aspects of the present invention generally relate to an information processing apparatus for giving a tactile sensation to a user while the user is performing a touch operation on a touch panel, and also to an information processing method therefor and a program.

2. Description of the Related Art

Recent years have seen a widespread use of electronic apparatuses capable of displaying a camera-captured image on a display provided integrally with a touch panel. Meanwhile, as discussed in Japanese Patent Application Laid-Open No. 2010-053687, a certain electronic apparatus is capable of giving a more intuitive feeling of operation to a user. Such an apparatus gives a tactile sensation to the user, for example, by vibrating a housing during touch operations.

However, even if an image captured by an ordinary digital camera is displayed on a display apparatus with a touch panel, the user cannot obtain a tactile sensation of a subject when the user touches the screen.

Further, there has been no method of making a setting for giving a tactile sensation to a user through easy user-friendly operations when the user touches an image.

### SUMMARY

According to an aspect of the present invention, an information processing apparatus includes a display configured to display an image and includes an input plane for performing a touch operation, a detection unit configured to detect a touch operation on the input plane, a setting unit configured to set an area of an image corresponding to a touch position of the touch operation on the input plane as a tactile area for giving a tactile sensation, and a drawing control unit configured to apply a color over the displayed image by using a different color according to a tactile sensation type to enable recognizing the tactile area set by the setting unit.

Further features of the present disclosure will become apparent from the following description of exemplary embodiments with reference to the attached drawings.

### BRIEF DESCRIPTION OF THE DRAWINGS

FIG. 1 illustrates an electronic apparatus.

FIG. 2 illustrates an example of a data configuration of a palette table.

FIGS. 3 and 4 are flowcharts illustrating processing in a tactile sensation setting mode.

FIG. 5 illustrates an example of a data configuration of a tactile map.

FIGS. 6, 7, and 8 are flowcharts illustrating processing in the tactile sensation setting mode.

### DESCRIPTION OF THE EMBODIMENTS

Exemplary embodiments will be described below with reference to the accompanying drawings.

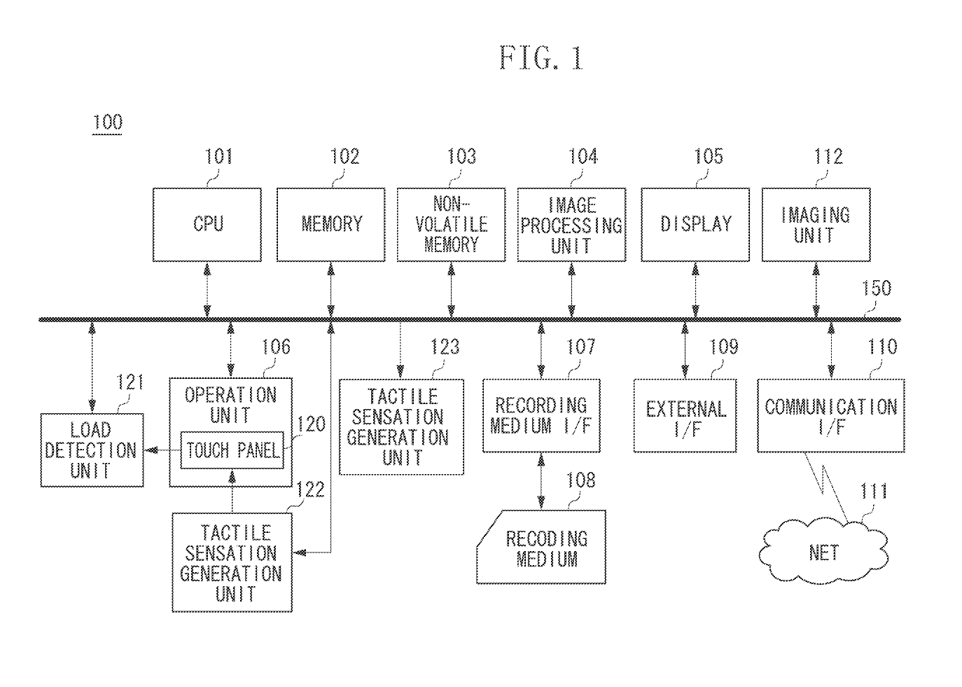

FIG. 1 illustrates an electronic apparatus 100 as an information processing apparatus. The electronic apparatus 100 can be configured, for example, by a mobile phone. As illustrated in FIG. 1, a central processing unit (CPU) 101, a memory 102, a non-volatile memory 103, an image processing unit 104, a display 105, an operation unit 106, a recording medium interface (I/F) 107, an external I/F 109, and a communication I/F 110 are connected to an internal bus 150. Further, an imaging unit 112, a load detection unit 121, a tactile sensation generation unit 122, and a tactile sensation generation unit 123 are connected to the internal bus 150. These units connected to the internal bus 150 can exchange data with each other via the internal bus 150.

The memory 102 includes, for example, a random access memory (RAM) such as a volatile memory employing semiconductor elements. The CPU 101 controls each unit of the electronic apparatus 100 by using the memory 102 as a work memory, for example, according to a program stored in the non-volatile memory 103. The non-volatile memory 103 stores image data, audio data, and other data, and various programs necessary for operations of the CPU 101. The non-volatile memory 103 includes, for example, a hard disk (HD) and a read only memory (ROM).

The image processing unit 104 performs various image processing on image data under control of the CPU 101. Image data subjected to image processing includes image data stored in the non-volatile memory 103 and a recording medium 108, image signals acquired via the external I/F 109, image data acquired via the communication I/F 110, and image data captured by the imaging unit 112.

Image processing performed by the image processing unit 104 includes analog-to-digital (A/D) conversion processing, digital-to-analog (D/A) conversion processing, encoding processing, compression processing, decoding processing, enlargement/reduction processing (resizing), noise reduction processing, and color conversion processing on image data. The image processing unit 104 is, for example, a dedicated circuit block for performing specific image processing. Further, depending on the type of image processing, the CPU 101 instead of the image processing unit 104 can execute image processing according to a program.

The display 105 displays an image and a graphical user interface (GUI) screen forming a GUI based on drawing control processing by the CPU 101. The CPU 101 generates a display control signal according to a program to control each unit of the electronic apparatus 100 to generate an image signal for presenting display on the display 105 and output the image signal on the display 105. The display 105 displays an image based on the image signal.

As another example, the electronic apparatus 100 may not have the display 105 but an interface for outputting an image signal for presenting display on the display 105. In this case, the electronic apparatus 100 displays an image on an external monitor (television).

The operation unit 106 is an input device for receiving user operations, for example, a text information input apparatus such as a keyboard, and a pointing device such as a mouse and a touch panel 120. The operation unit 106 may also be a button, a dial, a joy stick, a touch sensor, and a touch pad. The touch panel 120 is an input device planarly superimposed on top of the display 105, which outputs coordinate information according to a touched position. In other words, the touch panel 120 is provided at a position corresponding to the display 105. The touch panel 120 is an example of an input plane. The display 105 is an example of a display screen.

The recording media 108, such as a memory card, a compact disc (CD), and a digital versatile disc (DVD), can be attached to the recording medium I/F 107. The recording medium I/F 107 writes and reads data to/from the attached recording medium 108 under control of the CPU 101.

The external I/F 109 by cable or wirelessly connected with an external apparatus is an interface for inputting and outputting video and audio signals. The communication I/F 110 is an interface for transmitting and receiving various data such as files and commands by communicating (including telephone communication) with external apparatuses and the Internet 111.

The imaging unit 112 is a camera unit which includes an image sensor such as a charge-coupled device (CCD) sensor and a complementary metal-oxide semiconductor (CMOS) sensor, a zoom lens, a focus lens, a shutter, a diaphragm, a distance-measuring unit, and an A/D converter. The imaging unit 112 can capture still and moving images. Image data of an image captured by the imaging unit 112 is transmitted to the image processing unit 104, subjected to various processing by the image processing unit 104, and then recorded on the recording medium 108 as a still image file or a moving image file.

The CPU 101 receives coordinate information of a touch position output from the touch panel 120 via the internal bus 150. Then, the CPU 101 detects the following actions and states based on the coordinate information.

An action of touching the touch panel 120 with a finger or pen (hereinafter referred to as a touch-down)

A state where a finger or pen is in contact with the touch panel 120 (hereinafter referred to as a touch-on)

An action of moving a finger or pen held in contact with the touch panel 120 (hereinafter referred to as a move)

An action of detaching a finger or pen from the touch panel 120 (hereinafter referred to as a touch-up)

A state where a finger or pen is not in contact with the touch panel 120 (hereinafter referred to as a touch-off)

Performing a certain action, including a touch-down, a touch-up, and a move, on the input plane of the touch panel by touching the screen with a finger or pen and detaching it from the screen is referred to as a touch input or touch operation. When the CPU 101 detects a move, the CPU 101 further determines the moving direction of a finger or pen based on changes in coordinates of the touch position. More specifically, the CPU 101 determines vertical and horizontal components in the moving direction on the touch panel 120.

The CPU 101 also detects actions of a stroke, a flick, and a drag. When a user performs a touch-down, a move over a certain distance, and then a touch-up, the CPU 101 detects a stroke. When the user performs a move over a predetermined distance or longer at a predetermined speed or higher and then a touch-up in succession, the CPU 101 detects a flick. When the user performs a move over a predetermined distance or longer at lower than a predetermined speed, the CPU 101 detects a drag.

A flick refers to an action of quickly moving a finger over a certain distance held in contact with the touch panel 120 and then detaching the finger from the touch panel 120. In other words, a flick is an action of quickly flipping the surface of the touch panel 120 with a finger.

The touch panel 120 may be a panel of any type including the resistance film type, the capacitance type, the surface elastic wave type, the infrared type, the electromagnetic induction type, the image recognition type, and the optical sensor type.

The load detection unit 121 is provided integrally with the touch panel 120 through adhesion. The load detection unit 121 is a distortion gauge sensor which functions as a detection unit for detecting a position touched by the user. The load detection unit 121 detects a load (pressing force) applied to the touch panel 120 based on a phenomenon that the touch panel 120 is slightly bent (distorted) owing to the pressing force of the touch operation. As another example, the load detection unit 121 may be provided integrally with the display 105. In this case, the load detection unit 121 detects a load applied to the touch panel 120 via the display 105.

The tactile sensation generation unit 122 generates a tactile sensation to be applied to an operation element for operating the touch panel 120, such as a finger and a pen. The tactile sensation generation unit 122 is provided integrally with the touch panel 120 through adhesion. The tactile sensation generation unit 122 is a piezoelectric element, more specifically a piezoelectric vibrator, which vibrates in any amplitude and at any frequency under control of the CPU 101. This enables the touch panel 120 to vibrate in a bent state. The vibration of the touch panel 120 is transmitted to the operation element as a tactile sensation. In other words, the tactile sensation generation unit 122 itself vibrates to apply a tactile sensation to the operation element.

As another example, the tactile sensation generation unit 122 may be provided integrally with the display 105. In this case, the tactile sensation generation unit 122 vibrates the touch panel 120 in a bent state via the display 105.

The CPU 101 vibrates the tactile sensation generation unit 122 in various patterns by changing the amplitude and frequency of the tactile sensation generation unit 122, thus generating various tactile sensation patterns.

Further, the CPU 101 can control a tactile sensation based on the touch position detected on the touch panel 120 and the pressing force detected by the load detection unit 121. For example, in response to a touch operation by using the operation element, the CPU 101 may detect a touch position corresponding to a button icon displayed on the display 105, and the load detection unit 121 detects a pressing force having a predetermined value or larger. In this case, the CPU 101 generates a vibration having about one cycle. This enables the user to perceive a tactile sensation like a click feeling produced when a mechanical button is pressed.

Further, only when the CPU 101 detects a pressing force having a predetermined value or larger in a state where a touch at the button icon position is detected, the CPU 101 executes the function of a button icon. In other words, when the CPU 101 detects a weak pressing force as when a button icon is simply touched, the CPU 101 does not execute the function of the button icon. This enables the user to operate a button icon with a similar feeling to a feeling produced when a mechanical button is pressed.

The load detection unit 121 is not limited to a distortion gauge sensor. As another example, the load detection unit 121 may include a piezoelectric element. In this case, the load detection unit 121 detects a load based on a voltage output from the piezoelectric element in response to a pressing force. Further, in this case, a pressure element as the load detection unit 121 may be identical to a pressure element as the tactile sensation generation unit 122.

The function of the tactile sensation generation unit 122 is not limited to generating a vibration by using a pressure element. As another example, the tactile sensation generation unit 122 may generate an electrical tactile sensation. For example, the tactile sensation generation unit 122 includes a conductive layer panel and an insulator panel. Similar to the touch panel 120, the conductive layer panel and the insulator panel are planarly superimposed on the display 105. When the user touches the insulator panel, positive charges are stored in the conductive layer panel. In other words, the tactile sensation generation unit 122 can generate a tactile sensation as an electrical stimulus by storing positive charges in the conductive layer panel. Further, the tactile sensation generation unit 122 may give a feeling (tactile sensation) that the skin is pulled by the Coulomb force.

As still another example, the tactile sensation generation unit 122 may include a conductive layer panel which enables determining whether positive charges are to be stored for each position on the panel. Then, the CPU 101 controls charge positions of positive charges. This enables the tactile sensation generation unit 122 to apply various tactile sensations such as a “harsh feeling”, a “rough feeling”, and a “smooth feeling” to the user.

The tactile sensation generation unit 123 vibrates the entire electronic apparatus 100 to generate a tactile sensation. The tactile sensation generation unit 123 includes, for example, an eccentric motor to achieve a well-known vibration function. This enables the electronic apparatus 100 to apply a tactile sensation to a user's hand holding the electronic apparatus 100 through a vibration generated by the tactile sensation generation unit 123.

The electronic apparatus 100 according to the present exemplary embodiment is provided with two operation modes: a tactile sensation setting mode and a tactile sensation reproducing mode. In the tactile sensation setting mode, when a touch-down on an image currently displayed on the display 105 is detected, a tactile sensation is set to an area corresponding to the touch-down in an image. In the tactile sensation reproducing mode, when a touch-down on an image, to which a tactile sensation was set in the tactile sensation setting mode, is detected, the tactile sensation set to an area where the touch-down was performed is generated to give a tactile sensation to the user.

In the tactile sensation setting mode, a tactile sensation palette is displayed on the display 105. The tactile sensation palette is a user interface for selecting a type and intensity of a tactile sensation, and includes a plurality of tactile buttons. Each of the plurality of tactile buttons corresponds to a plurality of tactile sensations in which at least one of a type and a intensity is different. The user can select a tactile sensation to be set to an image by touching a tactile button of the tactile sensation palette. In other words, the tactile sensation palette functions as an option display portion having a plurality of options for selecting the type and the intensity of a tactile sensation. The tactile sensation palette also includes an eraser button as another option. The eraser button is used to delete an already set tactile sensation.

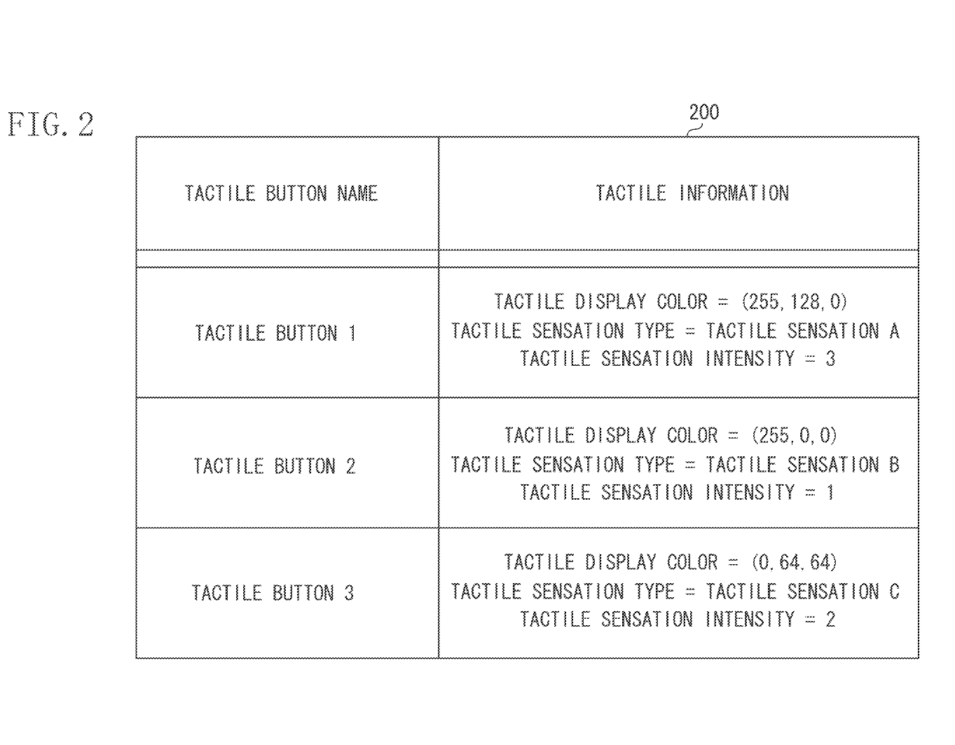

FIG. 2 illustrates an example of a data configuration of a palette table corresponding to the tactile sensation palette. A palette table 200 is information for associating tactile button names with tactile information. The palette table 200 is pre-stored, for example, in the non-volatile memory 103.

Tactile button names are names of the tactile buttons. Each of the tactile information includes a tactile display color, a tactile sensation type, and a tactile sensation intensity. The tactile sensation type is information for indicating the type of a tactile sensation, such as a “harsh feeling” and a “rough feeling.” The tactile sensation intensity is information for indicating the strength of a tactile sensation. A higher tactile sensation intensity can apply a stronger tactile sensation to the operation element. The tactile display color is a color applied on the relevant area when a tactile sensation indicated in the tactile information is set to an area in an image. As described in detail below, when a tactile sensation is set to an area, the relevant area is displayed in the tactile display color. This enables the user to visually grasp an area where a tactile sensation was set.

Referring to the palette table 200 illustrated in FIG. 2, a tactile button 1 is associated with tactile information including a tactile display color (255, 128, 0), a tactile sensation type “tactile sensation A”, and a tactile sensation intensity “3.” A tactile button 3 is associated with tactile information including a tactile display color (0, 64, 64), a tactile sensation type “tactile sensation C”, and a tactile sensation intensity “2.”

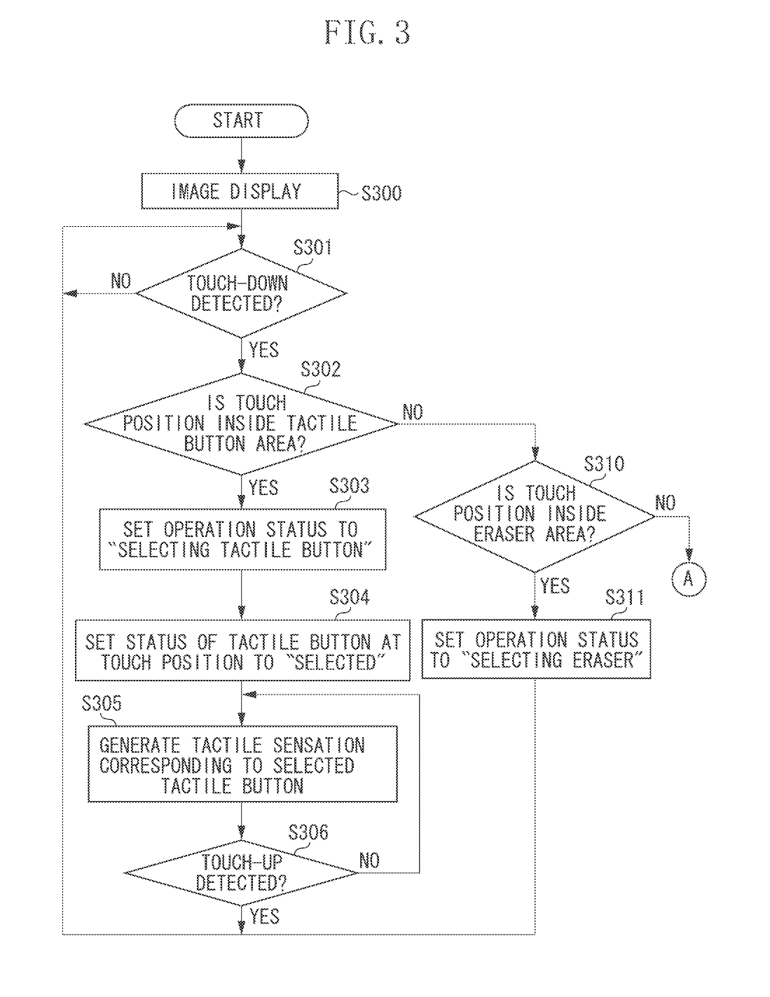

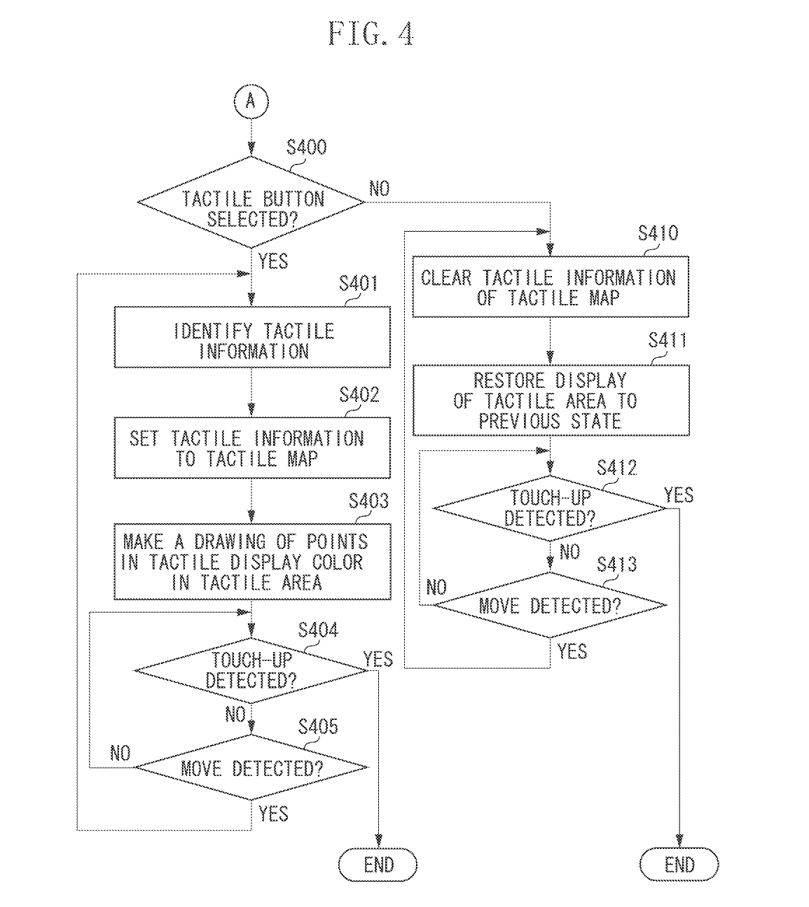

FIGS. 3 and 4 are flowcharts illustrating processing performed in the tactile sensation setting mode by the electronic apparatus 100. When the CPU 101 reads a program stored in the non-volatile memory 103 and executes the program, functions and processing of the electronic apparatus 100 (described later) can function as a setting unit for setting a tactile sensation to a desired area in an image and a unit for performing drawing control.

In step S300, the CPU 101 displays a processing target image on the display 105 (display processing). In step S301, the CPU 101 checks whether a touch-down is performed on the touch panel 120. When the CPU 101 detects a touch-down (YES in step S301), the processing proceeds to step S302. On the other hand, when the CPU 101 does not detect a touch-down (NO in step S301), the CPU 101 waits until a touch-down is detected. The processing in step S301 is an example of detection processing for detecting a touch-down (touch input).

In step S302, the CPU 101 checks whether a position on the touch panel 120 where a touch-down was performed, i.e., a touch position, is inside a tactile button area. A tactile button area refers to an area on the touch panel 120 corresponding to a tactile button display area on the display 105. After detecting the touch-down, the CPU 101 periodically identifies a touch position. When the CPU 101 determines that the touch position is inside a tactile button area (YES in step S302), the processing proceeds to step S303. On the other hand, when the CPU 101 determines that the touch position is outside a tactile button area (NO in step S302), the processing proceeds to step S310. In step S303, the CPU 101 receives a selection of a tactile button corresponding to the touch position, and sets the operation status of the tactile button corresponding to the touch position to “SELECTING TACTILE BUTTON.” As described above, each tactile button is associated with tactile information in the palette table 200. While the user is performing a touch operation on a tactile button in step S303, the tactile sensation generation unit 123 generates a tactile sensation based on the tactile information associated with the tactile button. This enables the user to select an option while confirming the tactile sensation to be set. In other words, the processing for receiving a selection of a tactile button in step S303 is an example of type reception processing for receiving a tactile sensation type specification and intensity reception processing for receiving a tactile sensation intensity specification.

In step S304, the CPU 101 changes the status of a tactile button arranged at a position corresponding to the touch position, from “DESELECTED” to “SELECTED”, in the tactile buttons. Statuses of the tactile buttons included in the tactile sensation palette are stored in the memory 102. In the initial state, “DESELECTED” is set to each tactile button.

In step S305, referring to the palette table 200, the CPU 101 identifies tactile information corresponding to the selected tactile button. The CPU 101 instructs the tactile sensation generation unit 122 to generate a tactile sensation of the type and intensity indicated by the identified tactile information. In response, the tactile sensation generation unit 122 generates a tactile sensation according to the instruction from the CPU 101.

As another example, in step S305, the CPU 101 may instruct the tactile sensation generation unit 123 instead of the tactile sensation generation unit 122 to generate a tactile sensation. In this case, the tactile sensation generation unit 123 generates a tactile sensation according to the relevant instruction from the CPU 101.

In step S306, the CPU 101 checks whether a touch-up is detected. When the CPU 101 detects a touch-up (YES in step S306), the processing proceeds to step S301. On the other hand, when the CPU 101 does not detect a touch-up (NO in step S306), the processing proceeds to step S305. In other words, while the touch-on state is continued, the CPU 101 continues to generate the tactile sensation in step S305.

Meanwhile, in step S310, the CPU 101 checks whether the touch position is inside the eraser area. The eraser area refers to an area on the touch panel 120 corresponding to the eraser button display area on the display 105. When the CPU 101 determines that the touch position is inside the eraser area (YES in step S310), the processing proceeds to step S311. On the other hand, when the CPU 101 determines that the touch position is not inside the eraser area, i.e., when the touch position is a position on the currently displayed image (NO in step S310), the processing proceeds to step S400 (FIG. 4). In step S311, the CPU 101 sets the operation status to “SELECTING ERASER.” Then, the processing proceeds to step S301.

In step S400 illustrated in FIG. 4, the CPU 101 checks whether a tactile button is currently selected. When the CPU 101 determines that a tactile button is currently selected (YES in step S400), the processing proceeds to step S401. On the other hand, when the CPU 101 determines that no tactile button is currently selected (NO in step S400), the processing proceeds to step S410. A case where no tactile button is currently selected means a case where the eraser button is currently selected. In step S401, the CPU 101 identifies tactile information corresponding to the relevant tactile button, referring to the palette table 200.

In step S402, the CPU 101 sets as a tactile area the area of an image displayed at a position on the display 105 (display screen) corresponding to the touch position (setting processing). More specifically, by setting the tactile information identified in step S401 to cells in a tactile map corresponding to the touch position, the CPU 101 sets as a tactile area the area of an image corresponding to the touch position.

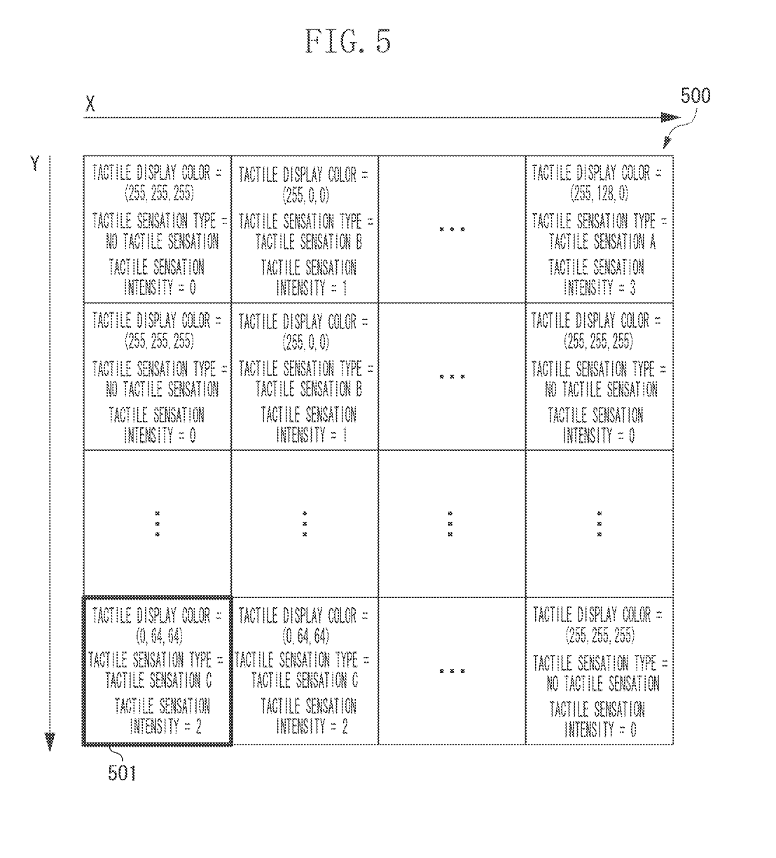

FIG. 5 illustrates an example of a data configuration of the tactile map. A tactile map 500 includes a plurality of cells. Referring to FIG. 5, a cell 501 indicates one cell. The tactile map 500 corresponds to the entire image. One cell corresponds to one pixel in the image. In other words, the tactile map 500 includes the same number of cells as the number of pixels included in the image.

More specifically, in step S402 illustrated in FIG. 4, the CPU 101 identifies cells corresponding to the touch position in the tactile map 500. Then, the CPU 101 sets to the identified cells the tactile information (the tactile display color, the tactile sensation type, and the tactile sensation intensity) identified in step S401.

In step S403, the CPU 101 draws point images of the tactile display color included in the tactile information identified in step S401 (the tactile information set to cells in step S402), at a position on the display 105 corresponding to the touch position. This enables the user to visually grasp a position where a tactile sensation was set within the currently displayed image. The tactile display color, preset in the palette table 200, is represented as a combination of three colors (R, G, and B). The intensity of each color is specified in a range from 0 to 255.

Although the tactile display color defined for each tactile button in the palette table 200 is not related to the display color of each tactile button displayed on the display 105, these two colors may be identical. When the tactile display color and the display color of a tactile button are identical, the tactile display color enables the user to visually grasp not only the tactile sensation set position but also the set tactile sensation type.

The processing in step S403 is an example of display processing for displaying the area corresponding to the touch position, i.e., a tactile area within the image displayed on the display 105 in a different display pattern from display patterns of other areas. The processing in step S403 is processing for drawing point images of the tactile display color so that the points are superimposed on the image displayed on the display 105. This processing does not change the currently displayed image itself.

In step S403, the CPU 101 needs to display the tactile area in a different display pattern from display patterns of other areas. Specific processing for achieving the display is not limited to the processing according to the present exemplary embodiment.

In the tactile sensation reproducing mode (described below), the CPU 101 does not perform processing for superimposing points onto the tactile area. In other words, in the tactile sensation reproducing mode, the tactile area is displayed in the same display pattern as display patterns of other areas.

In step S404, the CPU 101 checks whether a touch-up is detected. When the CPU 101 detects a touch-up (YES in step S404), the processing exits the flowchart. On the other hand, when the CPU 101 does not detect a touch-up (NO in step S404), then in step S405, the CPU 101 checks whether a move is detected. When the CPU 101 detects a move (YES in step S405), the processing proceeds to step S401. On the other hand, when the CPU 101 does not detect a move (NO in step S405), the processing proceeds to step S404.

Meanwhile, in step S410, the CPU 101 clears (deletes) the tactile information (the tactile display color, the tactile sensation type, and the tactile sensation intensity) set to cells corresponding to the touch position in the tactile map 500. The processing in step S410 is an example of cancel processing for canceling the setting of the tactile area at the touch position. In step S411, the CPU 101 restores the display of the tactile area corresponding to the touch position to the previous display pattern. More specifically, the CPU 101 deletes the point images drawn in step S403.

In step S412, the CPU 101 checks whether a touch-up is detected. When the CPU 101 detects a touch-up (YES in step S412), the processing exits the flowchart. On the other hand, when the CPU does not detect a touch-up (NO in step S412), then in step S413, the CPU 101 checks whether a move is detected. When the CPU 101 detects a move (YES in step S413), the processing proceeds to step S410. On the other hand, when the CPU 101 does not detect a move (NO in step S413), the processing proceeds to step S412. When the tactile sensation setting mode ends, the CPU 101 records the tactile information set to the tactile map 500 in a header portion of the currently displayed image, thus associating the image with the tactile information.

As described above, in the tactile sensation setting mode, the CPU 101 can receive a selection of a tactile sensation in response to a user operation, and set the tactile sensation at any position of the currently displayed image in response to subsequent touch operations. Further, the CPU 101 can receive a selection of the eraser and clear an existing tactile sensation in response to subsequent touch operations.

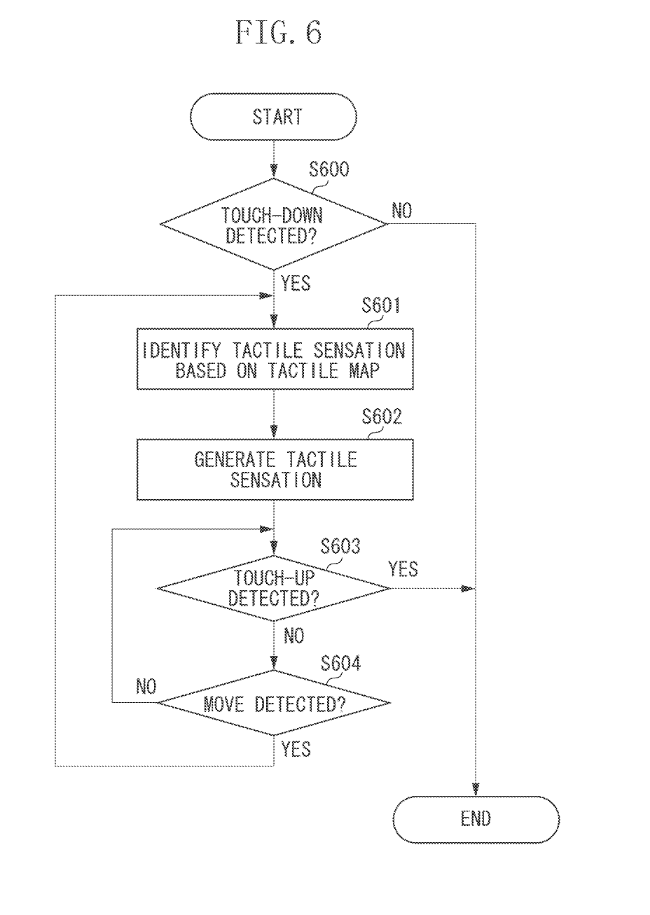

FIG. 6 is a flowchart illustrating processing in the tactile sensation reproducing mode. In step S600, the CPU 101 checks whether a touch-down is detected. When the CPU 101 detects a touch-down (YES in step S600), the processing proceeds to step S601. On the other hand, when the CPU 101 does not detect the touch-down (NO in step S600), the processing exits the flowchart.

In step S601, referring to the tactile map 500, the CPU 101 identifies a tactile sensation type and a tactile sensation intensity set to cells corresponding to a touch position. In step S602, the CPU 101 instructs the tactile sensation generation unit 122 to generate a tactile sensation having the tactile sensation type and the tactile sensation intensity identified in step S601. The tactile sensation generation unit 122 generates a tactile sensation according to the instruction from the CPU 101. As another example, in step S602, the CPU 101 may instruct the tactile sensation generation unit 123, instead of the tactile sensation generation unit 122, to generate a tactile sensation. In this case, the tactile sensation generation unit 123 generates a tactile sensation according to the instruction from the CPU 101.

In step S603, the CPU 101 checks whether a touch-up is detected. When the CPU 101 detects a touch-up (YES in step S603), the processing exits the flowchart. On the other hand, when the CPU 101 does not detect a touch-up (NO in step S603), then in step S604, the CPU 101 checks whether a move is detected. When the CPU 101 detects a move (YES in step S604), the processing proceeds to step S601. On the other hand, when the CPU 101 does not detect a move (NO in step S604), the processing proceeds to step S603.

As described above, in the tactile sensation reproducing mode, when the CPU 101 detects a touch input to the image by the user, the CPU 101 can generate a tactile sensation set at the touch position to give a tactile sensation to the user.

As described above, the electronic apparatus 100 according to the present exemplary embodiment enables setting of a tactile sensation to be applied to an operation element when the user touches an image. Further, the electronic apparatus 100 enables generating of the set tactile sensation.

An electronic apparatus 100 according to a second exemplary embodiment will be described below. The electronic apparatus 100 according to the second exemplary embodiment receives from the user a specification of a setting range corresponding to a plurality of cells in the tactile map 500. Then, the electronic apparatus 100 sets the area of an image corresponding to the setting range as a tactile area. The following describes the electronic apparatus 100 according to the second exemplary embodiment centering on differences from the electronic apparatus 100 according to the first exemplary embodiment.

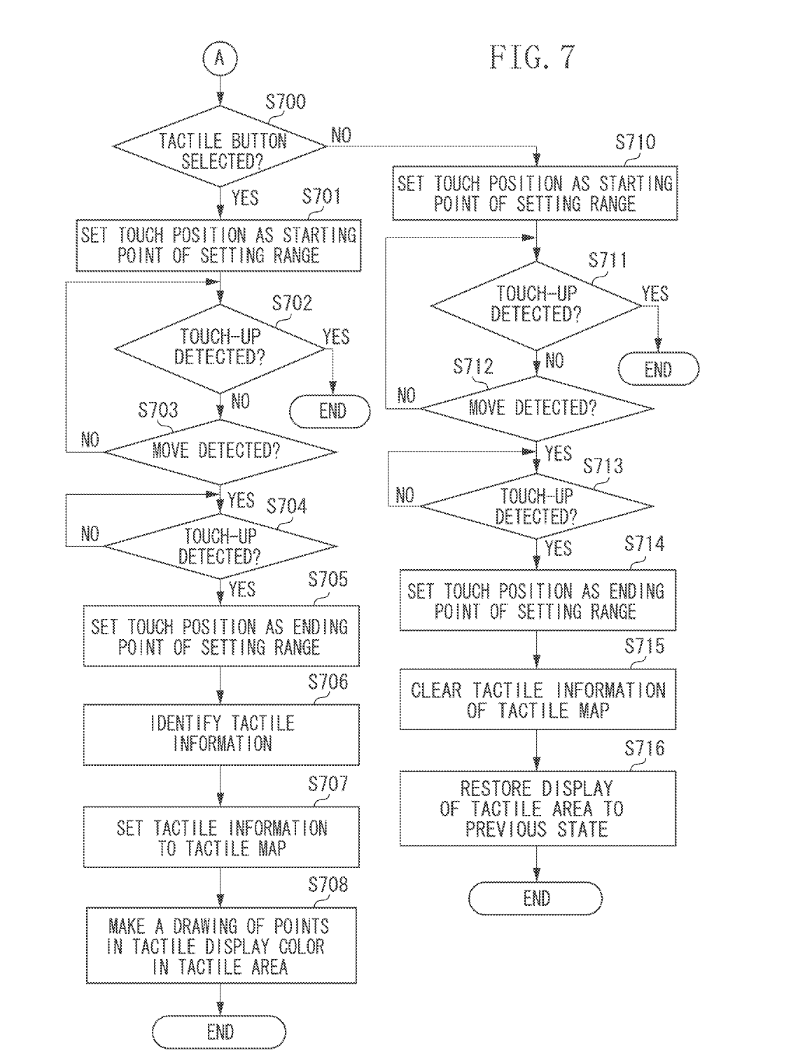

FIG. 7 is a flowchart illustrating processing performed in the tactile sensation setting mode by the electronic apparatus 100 according to the second exemplary embodiment. Similar to the electronic apparatus 100 according to the first exemplary embodiment, the electronic apparatus 100 according to the second exemplary embodiment performs the processing in steps S300 to S311 (FIG. 3). When the touch position is neither a tactile button area nor the eraser area (NO in step S302, NO in step S310), i.e., when the touch position is a position on the currently displayed image, the processing proceeds to step S700 illustrated in FIG. 7.

In step S700, the CPU 101 checks whether a tactile button is selected. When the CPU 101 detects that a tactile button is selected (YES in step S700), the processing proceeds to step S701. On the other hand, when the CPU detects that no tactile button is selected (NO in step S700), the processing proceeds to step S710.

In step S701, the CPU 101 sets the touch position as a starting point of a setting range. In step S702, the CPU 101 checks whether a touch-up is detected. When the CPU 101 detects a touch-up (YES in step S702), the processing exits the flowchart. On the other hand, when the CPU 101 does not detect a touch-up (NO in step S702), then in step S703, the CPU 101 checks whether a move is detected. When the CPU 101 detects a move (YES in step S703), the processing proceeds to step S704. On the other hand, when the CPU 101 does not detect a move (NO in step S703), the processing proceeds to step S702.

In step S704, the CPU 101 checks whether a touch-up is detected. When the CPU 101 detects a touch-up (YES in step S704), the processing proceeds to step S705. On the other hand, when the CPU 101 does not detect a touch-up (NO in step S704), the CPU 101 waits until a touch-up is detected.

In step S705, the CPU 101 sets the touch position where a touch-up was detected as an ending point of the setting range. Then, the CPU 101 sets as a setting range a rectangular area determined by the starting point set in step S701 and the ending point as diagonal points. The processing in steps S701 to S705 is an example of range reception processing for receiving a specification of a setting range.

In step S706, referring to the palette table 200, the CPU 101 identifies tactile information corresponding to the selected tactile button. In step S707, the CPU 101 identifies the area of an image corresponding to the setting range as a tactile area, and sets the tactile information identified in step S706 to cells in the tactile map 500 corresponding to the identified tactile area. In step S708, the CPU 101 draws point images of the tactile display color included in the tactile information identified in step S706 (the tactile information set to cells in step S707) at a position on the display 105 corresponding to the setting range.

Meanwhile, in step S710, the CPU 101 sets the touch position as a starting point of a setting range. In step S711, the CPU 101 determines whether a touch-up is detected. When the CPU 101 detects a touch-up (YES in step S711), the processing exits the flowchart. On the other hand, when the CPU 101 does not detect a touch-up (NO in step S711), then in step S712, the CPU 101 checks whether a move is detected. When the CPU 101 detects a move (YES in step S712), the processing proceeds to step S713. On the other hand, when the CPU 101 does not detect a move (NO in step S712), the processing proceeds to step S711.

In step S713, the CPU 101 checks whether a touch-up is detected. When the CPU 101 detects a touch-up (YES in step S713), the processing proceeds to step S714. On the other hand, when the CPU 101 does not detect a touch-up (NO in step S713), the CPU 101 waits until a touch-up is detected.

In step S714, the CPU 101 sets the touch position where a touch-up was detected as an ending point of the setting range. Then, the CPU 101 sets as a setting range a rectangular area determined by the starting point set in step S710 and the ending point as diagonal points. In step S715, the CPU 101 clears (deletes) the tactile information (the tactile display color, the tactile sensation type, and the tactile sensation intensity) set to cells corresponding to the setting range in the tactile map 500. In step S716, the CPU 101 restores the display of the tactile area corresponding to the setting range to the previous display pattern. More specifically, the CPU 101 deletes the points drawn in step S708.

As described above, the electronic apparatus 100 according to the second exemplary embodiment can set and delete a tactile sensation in a unit of a setting range specified by the user. This enables the user to give an instruction to set and delete tactile sensations in a wide range with one operation.

Other configurations and processing of the electronic apparatus 100 according to the second exemplary embodiment are similar to those of the electronic apparatus 100 according to the first exemplary embodiment.

An electronic apparatus 100 according to a third exemplary embodiment will be described below. According to a user instruction, the electronic apparatus 100 according to the third exemplary embodiment sets a tactile area to a touch position, and, at the same time, changes the color of pixels in the image corresponding to the touch position. The following describes the electronic apparatus 100 according to the third exemplary embodiment centering on differences from the electronic apparatus 100 according to the first exemplary embodiment.

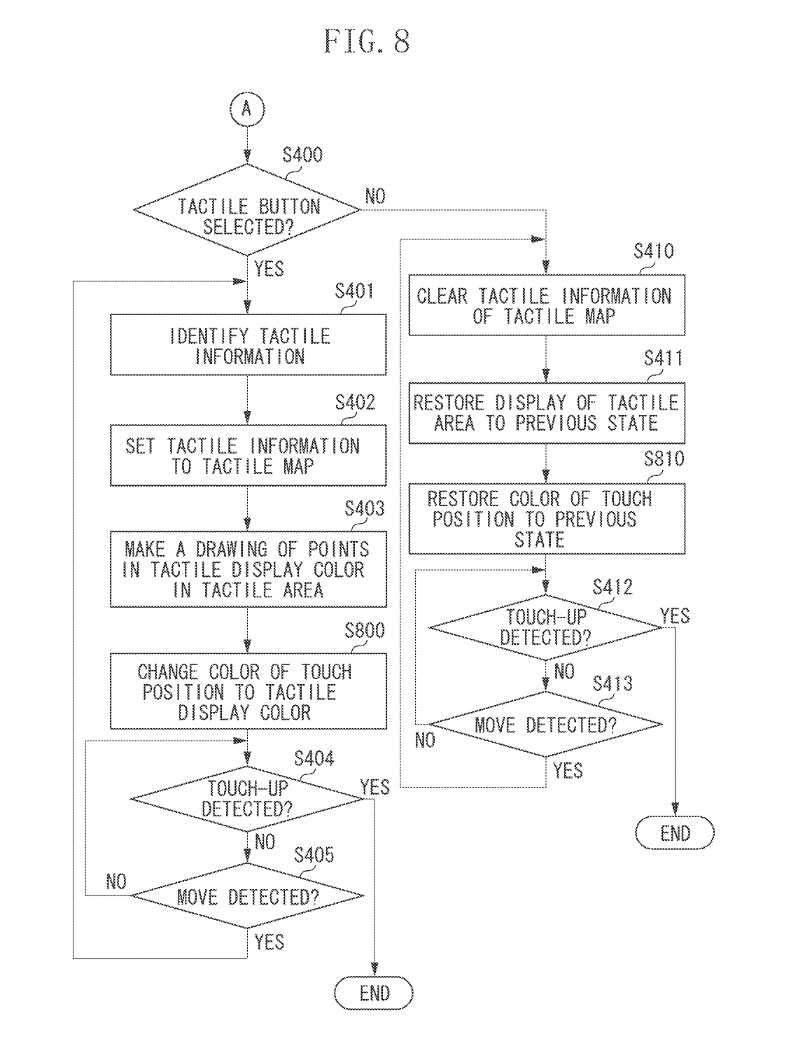

FIG. 8 is a flowchart illustrating processing performed in the tactile sensation setting mode by the electronic apparatus 100 according to the third exemplary embodiment. Similar to the electronic apparatus 100 according to the first exemplary embodiment, the electronic apparatus 100 according to the third exemplary embodiment performs the processing in steps S300 to S311 (FIG. 3). The processing in step S400 and subsequent steps (FIG. 4) is almost the same as the processing of the electronic apparatus 100 according to the first exemplary embodiment. Referring to FIG. 8, processing identical to processing illustrated in FIG. 4 is assigned the same reference numerals.

As illustrated in FIG. 8, in step S403, the CPU 101 of the electronic apparatus 100 according to the third exemplary embodiment draws point images of the tactile display color in the tactile area. Then, the processing proceeds to step S800. In step S800, the CPU 101 changes the color of pixels at a position in the image corresponding to the touch position, to the tactile display color. Then, the processing proceeds to step S404. In other words, in step S800, the CPU 101 overwrites the image data itself to update the image data. The processing in step S800 is an example of image editing processing. The processing in step S800 needs to be executed after the processing in step S401 and before the processing in step S404. The processing order is not limited to the processing order according to the present exemplary embodiment.

Meanwhile, in step S411, the CPU 101 restores the display of the tactile area to the previous display pattern. Then, in step S810, the CPU 101 restores the color of pixels at a position in the image corresponding to the touch position from the tactile display color to the previous pixel color. Then, the processing proceeds to step S412. The processing in step S810 needs to be executed after the processing in step S400 and before the processing in step S412. The processing order is not limited to the processing order according to the present exemplary embodiment.

As described above, the electronic apparatus 100 according to the third exemplary embodiment can set a tactile sensation at a position specified by the user, and, at the same time, edit an image so that the display color is changed. Further, the electronic apparatus 100 can clear a tactile sensation at a position specified by the user, and, at the same time, edit an image so that the display color is restored to the previous image color.

Other configurations and processing of the electronic apparatus 100 according to the third exemplary embodiment are similar to those of the electronic apparatus 100 according to the first and the second exemplary embodiments.

As an example of a modification of the electronic apparatus 100 according to the third exemplary embodiment, the CPU 101 may receive from the user not only a specification of tactile information but also a specification of a display color in the tactile sensation palette (color reception processing). In this case, in step S800, the CPU 101 needs to edit an image so that the color of pixels at a position in the image corresponding to the touch position is changed to a specified color.

### Other Exemplary Embodiments

Additional embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the above-described exemplary embodiments, it is possible to set a tactile sensation to be applied to an operation element when a user touches an image.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-000445 filed Jan. 6, 2014, which is hereby incorporated by reference herein in its entirety.

What is claimed is:

1. An information processing apparatus comprising:
a display configured to display an image and includes an input plane for performing a touch operation;
a detection unit configured to detect a touch operation on the input plane;
a setting unit configured to set an area of an image corresponding to a touch position of the touch operation on the input plane as a tactile area for giving a tactile sensation; and
a drawing control unit configured to apply a color over the displayed image by using a different color according to a tactile sensation type to enable recognizing the tactile area set by the setting unit.

2. The information processing apparatus according to claim 1, further comprising:
a tactile sensation generation unit configured to generate a tactile sensation while a user is performing a touch operation on the input plane,
wherein, when the user performs a touch operation to the tactile area while the image having the tactile sensation setting is being displayed, the tactile sensation generation unit generates a tactile sensation.

3. The image processing apparatus according to claim 1, further comprising:
a display control unit configured to display an option display portion having a plurality of options for selecting the tactile sensation type,
wherein a tactile sensation type to be set to the image is determined by performing a touch operation on the option display portion.

4. The image processing apparatus according to claim 3, further comprising:
a tactile sensation generation unit configured to generate a tactile sensation while the user is performing a touch operation on the input plane,
wherein, while the user is performing a touch operation on the option in the option display portion, a tactile sensation corresponding to the touched option is generated.

5. The image processing apparatus according to claim 3, wherein the plurality of options includes an option for deleting a tactile sensation already set to the image.

6. The image processing apparatus according to claim 3, further comprising:
a recording unit configured to overwrite the image with a color in accordance with the determined tactile sensation type.

7. A method for controlling an image processing apparatus including a display configured to display an image that includes an input plane for performing a touch operation, the method comprising:
detecting a touch operation on the input plane;
setting an area of an image corresponding to a touch position of the touch operation on the input plane as a tactile area for giving a tactile sensation; and
controlling applying of a color over the displayed image by using a different color according to a tactile sensation type to enable recognizing the tactile area.

8. The method for controlling an image processing apparatus according to claim 7, the method further comprising:
generating a tactile sensation while a user is performing a touch operation on the input plane,
wherein, when the user performs a touch operation to the tactile area while the image having the tactile sensation setting is being displayed, a tactile sensation is generated

9. The method for controlling an image processing apparatus according to claim 7, the method further comprising:
displaying an option display portion having a plurality of options for selecting the tactile sensation type,
wherein a tactile sensation type to be set to the image is determined by performing a touch operation on the option display portion.

10. The method for controlling an image processing apparatus according to claim 9, the method further comprising:
generating a tactile sensation while the user is performing a touch operation on the input plane,
wherein, while the user is performing a touch operation on the option in the option display portion, a tactile sensation corresponding to the touched option is generated.

11. The method for controlling an image processing apparatus according to claim 9, wherein the plurality of options includes an option for deleting a tactile sensation already set to the image.

12. The method for controlling an image processing apparatus according to claim 10, the method further comprising:
overwriting the image with a color in accordance with the determined tactile sensation type.
